(19) United States
(12) Patent Application Publication
(10) Pub. No.: US 2011/0028046 A1
(43) Pub. Date: Feb. 3, 2011

(54) Electrical connector having plural types of contacts

(75) Inventors: Chien-Chiung Wang, Tu-Cheng (TW); Qing-Man Zhu, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/804,864

(22) Filed: Jul. 29, 2010

(30) Foreign Application Priority Data
Jul. 29, 2009 (TW) 98125601

(51) Int. Cl. H01R 24/00

(52) U.S. Cl. 439/660

(57) ABSTRACT

A connector (100) includes an insulative housing (10), and a number of contacts (2) received in the insulative housing. The insulative housing includes a number of first type of contacts (21) in accordance with the USB 2.0 standard, a pair of second type of contacts (22) for transmitting clock signal, and a pair of third type of contacts (23) for transmitting power signal.

### BACKGROUND OF THE INVENTION

1. Field of the Invention

The present invention relates to a connector, and more particularly to the structure of the connector.

2. Description of Related Arts

USB (Universal Serial Bus) connector is widely used in PC, MP3 or other electronic products for transmitting data and power signals. U.S. Pat. No. 6,165,016, issued on Dec. 26, 2000, to Lai, discloses a related art. According to the disclosure, the USB connector comprises a pair of signal contacts and a pair of power contacts. When an electronic product is used for transmitting high speed signal, it is necessary to transmit clock signal for improving the transmitting efficiency of high speed signal. The electronic product often has a number of CPUs. It is necessary to provide a number of electrical sources for driving the CPUs. Therefore, the USB connector could not meet the above-mentioned requirements.

Hence, an improved connector is required to overcome the above-mentioned disadvantages of the related art.

### SUMMARY OF THE INVENTION

An object of the present invention is to provide a connector having a number of types of contact for performing different functions.

To achieve the above-mentioned object, a connector comprises an insulative housing and a plurality of contacts received in the insulative housing. The contacts comprises a plurality of first type of contacts having a feature in accordance with the USB 2.0 standard, a pair of second type of contacts for transmitting clock signal, and a pair of third type of contacts for transmitting power signal.

According to one aspect of the present invention, the connector has a number of types of contact for transmitting different signals. Therefore, the connector may be satisfied with the many requirements of the electronic product.

### BRIEF DESCRIPTION OF THE DRAWING

FIG. 1 is a perspective view of an electrical connector in accordance with the present invention connected with a pair of cables;

FIG. 2 is another perspective view similar to FIG. 1, taken from another aspect;

FIG. 3 is a partly exploded view of the electrical connector connected with the pair of cable as shown in FIG. 1;

FIG. 4 is a perspective view of the insulative housing and contacts of the electrical connector as shown in FIG. 3; and

FIG. 5 is a front view of the electrical connector as shown in FIG. 1.

### DETAILED DESCRIPTION OF THE PREFERRED EMBODIMENT

Reference will now be made in detail to a preferred embodiment of the present invention.

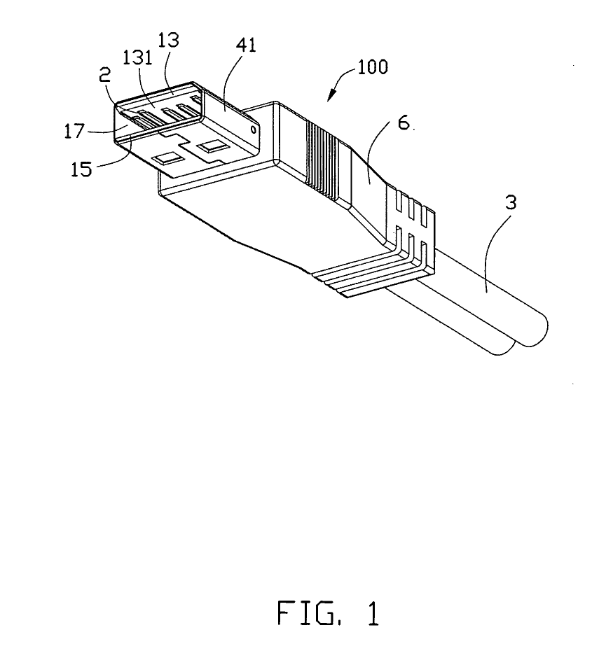

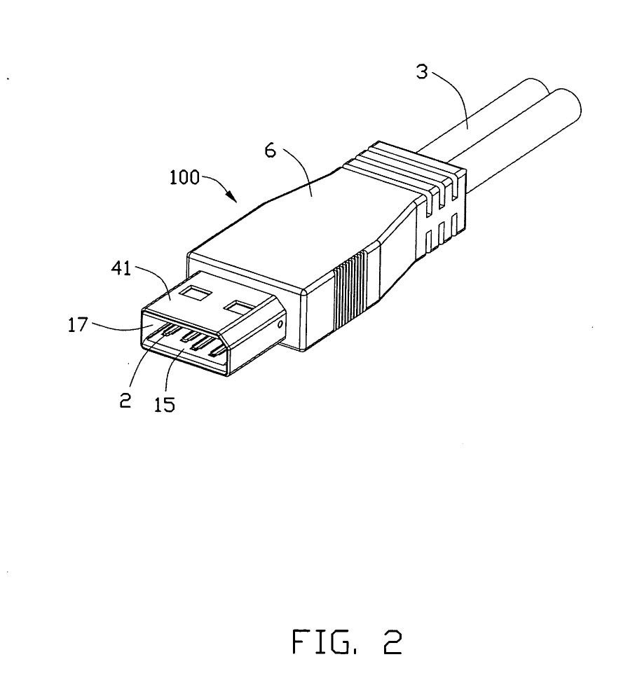

Referring to FIGS. 1-4, a connector 100 made in accordance with a preferred embodiment of the present invention connected with a pair of cables 3 comprises an insulative housing 1, a number of contacts 2 received in the insulative housing 1, and a conductive body 4 enclosing the insulative housing 1.

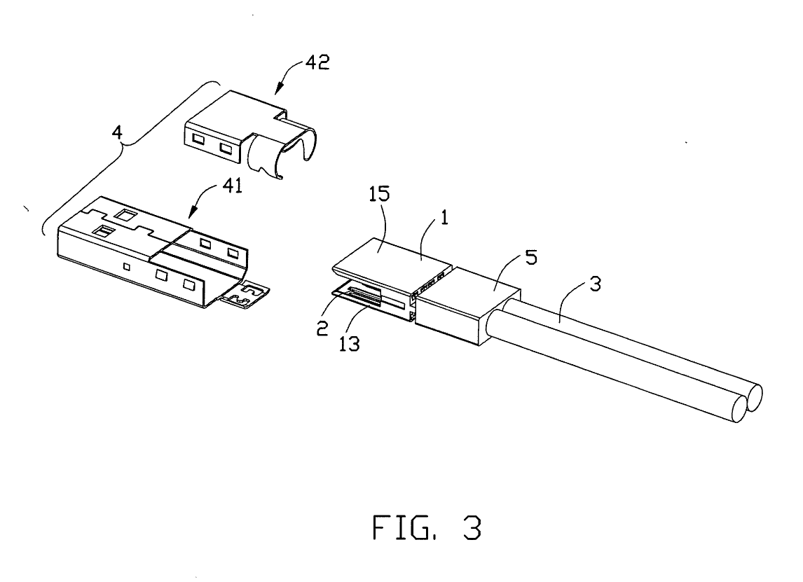

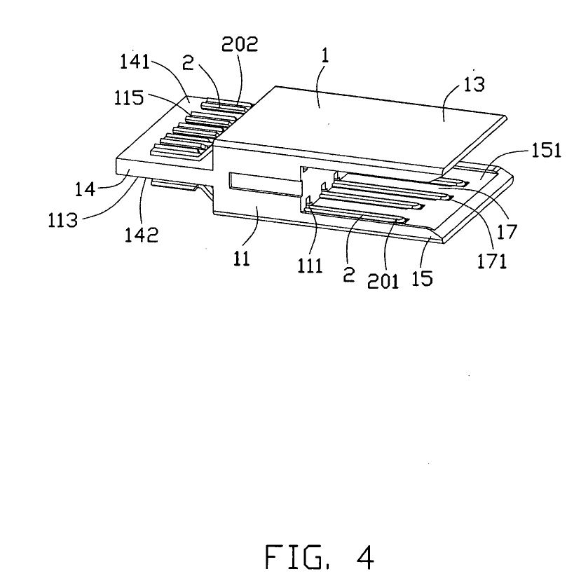

Referring to FIGS. 3 and 4, the insulative housing 1 comprises a base portion 11, a top tongue plate 13 extending from a top end of the base portion 11 along a first direction, a bottom tongue plate 15 extending from an opposite end and along the first direction, a middle tongue plate 14 extending form a middle portion of the base portion 11 along a second direction opposite to the first direction. The top and the bottom tongue plates 13, 15 cooperate to define a receiving room 17 for receiving a portion of a mating connector. The top tongue plate 13 has a first inner surface 131. The bottom tongue plate 15 has a second inner surface 151 facing to the first inner surface 131 of the top tongue plate 13. Both of the first and second inner surfaces 131, 151 define a number of cavities 171. The middle tongue plate 14 has a top surface 141 and a bottom surface 142. The base portion 11 defines a number of through holes 111.

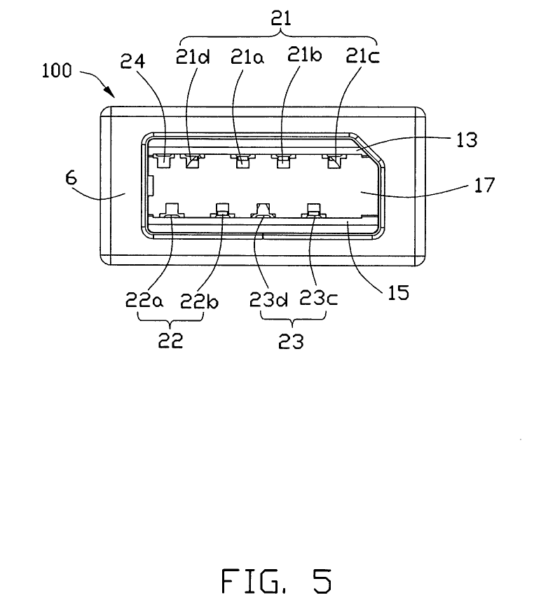

Referring to FIGS. 1-5, the contacts 2 comprise a plurality of first type of contacts 21 in accordance with the USB 2.0 standard, a pair of second type of contacts 22 for transmitting clock signal, a pair of third type of contacts 23 for transmitting power signal, and a fourth type of contact 24 for transmitting anti-error signal, cryptographic signal or other signal according to different requirements. Each of the contacts 2 has a mating portion 201 for electrically connecting with the mating connector, and an end portion 202 opposite to the mating portion 201 for electrically connecting with the cable 3. The first type of contacts 21 comprise a pair of signal contacts 21a, 21b and a pair of power contacts 21c, 21d. The pair of second type of contacts 22 comprise a first clock contact 22a for transmitting positive clock signal, and a second clock contact 22b for transmitting negative clock signal. The pair of the third type of contacts 23 comprise a first power contact 23a for transmitting positive power signal, and a second power contact 23b for transmitting negative power signal. The first type of contacts 21 and the fourth type of contact 24 are disposed on the top end of the base portion 11 and received in the corresponding through holes 111 respectively. Each of the mating portions 201 of the first type of contact 21 and the fourth type of the contact 24 are received in corresponding cavities 171 of the inner surface 131 of the top tongue plate 13 respectively. The fourth type of contact 24 is disposed on a side of the plurality of the first type of contacts 21. The end portions 202 of the first type of contacts 21 and the forth type of the contact 24 are disposed on the top surface 141 of the middle tongue plate 14. The pair of the second type of contacts 22 and the pair of the third type of the contacts 23 are disposed on the bottom end of the base portion 11 and received in the corresponding through holes 111 respectively. Each of the mating portions 201 of the pair of the second type of contact 22 and the pair of the third type of contacts 23 are received in the corresponding cavities 171 of the inner surface 151 of the bottom tongue plate 15 respectively. The end portions 202 of the pair of the second type of contact 22 and the pair of the third type of the contact 23 are disposed on the bottom surface 142 of the middle tongue plate 14.

Referring to FIGS. 1-4, the conductive body 4 comprises a top body 41 and a bottom body 42 mated with the top body 41.

Referring to FIGS. 1-4, when the pair of the cables 3 are connected with the electrical connector 100, the cables 3 are electrically connected with the end portions 202 of the plurality of contacts 2. An inner molding member 5 is over molded on the area of the cables 3 connected with the end portions 202 of the plurality of the contacts 2 for protecting the electrical connection. The top and the bottom bodies 41, 42 cooperate to enclose the insulative housing 10 and the inner molding member 5. An outer molding member 6 is over molded on a portion of the conductive body 4 and a portion of the pair of cables 3.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector, comprising:
an insulative housing; and
a plurality of contacts received in the insulative housing and comprising:
a plurality of first type of contacts in accordance with the USB 2.0 standard;
a pair of second type of contacts for transmitting clock signal; and
a pair of third type of contacts for transmitting power signal.

2. The connector as recited in claim 1, wherein the plurality of contacts comprise a fourth type of contact.

3. The connector as recited in claim 2, wherein the fourth type of contact is disposed on a side of the plurality of first type of contacts.

4. The connector as recited in claim 2, wherein the fourth type of contact is used for transmitting cryptographic signal.

5. The connector as recited in claim 2, wherein the fourth type of contact is used for transmitting anti-error signal.

6. The connector as recited in claim 1, wherein the insulative housing comprises a base portion, a top and a bottom tongue plates extending from a top and a bottom ends of the base portion in a first direction and spaced apart from each other, and a receiving room defined between the top and the bottom tongue plates for receiving a mating connector.

7. The connector as recited in claim 6, wherein said top tongue plates has a first inner surface, the bottom tongue plate has a second inner surface facing the first inner surface, and the contacts are disposed on the first inner surface of the top tongue plate and the second inner surfaces of the bottom tongue plates for electrically connecting with the mating connector.

8. The connector as recited in claim 7, wherein each of the top and the bottom tongue plates each has a plurality of cavities, each of the contacts having a mating portion received in a corresponding cavity.

9. The connector as recited in claim 8, wherein the base portion has a plurality of through holes communication with the cavities, each of the contacts mounted in a corresponding through hole.

10. The connector as recited in claim 7, wherein the first type of contacts are disposed on the top tongue plate.

11. The connector as recited in claim 7, wherein the second and the third type of contacts are disposed on the bottom tongue plate.

12. The connector as recited in claim 6, wherein the insulative housing comprises a middle tongue plate extending from a middle portion of the top and the bottom ends of the base portion in a second direction opposite to the first direction.

13. The connector as recited in claim 12, wherein the middle tongue plate has a top surface and a bottom surface, the contacts each having an end portion disposed on the top and the bottom surfaces for electrically connecting with a cable.

14. An electrical connector comprising:
an insulative housing defining a mating port with opposite first and second mating faces thereof in a vertical direction,
a plurality of first contacts disposed on the first mating face and essentially being traditional USB contacts;
a plurality of second contacts and a plurality of third contacts both located upon the second mating face under condition that said first contacts are offset, in a top view, from both said second contacts and said third contacts along a transverse direction perpendicular to said vertical direction;
wherein
the second contacts are clock contacts and the third contacts are power contacts.

15. The electrical connector as claimed in claim 14, wherein said mating port defines a chamfered corner around the first mating face.

16. The electrical connector as claimed in claim 14, wherein said second contacts and said third contacts are equipped with a same pitch arrangement with the first contacts under condition that the second contacts are dimensioned as long as signal contacts of the first contacts while the third contacts are dimensioned as long as power contacts of the first contacts.

17. The electrical connector as claimed in claim 14, wherein the mating port defines a cavity, and the first face and the second face are located by two sides of the cavity and facing toward each other.

18. The electrical connector as claimed in claim 17, wherein said connector is a plug connector with a cable extending rearwardly therefrom.
